(19) United States
(12) Patent Application Publication
(10) Pub. No.: US 2021/0019348 A1
(43) Pub. Date: Jan. 21, 2021

(54) OPTIMAL SOLUTION SEARCH APPARATUS, OPTIMAL SOLUTION SEARCH METHOD AND PROGRAM

(71) Applicant: NIPPON TELEGRAPH AND TELEPHONE CORPORATION, Tokyo (JP)

(72) Inventors: Shinsaku SAKAUE, Tokyo (JP); Naoki MARUMO, Tokyo (JP); Masaaki NAGATA, Tokyo (JP)

(73) Assignee: NIPPON TELEGRAPH AND TELEPHONE CORPORATION, Tokyo (JP)

(21) Appl. No.: 17/040,035

(22) PCT Filed: Feb. 21, 2019
(86) PCT No.: PCT/JP2019/006528

§ 371 Date: Sep. 21, 2020

(30) Foreign Application Priority Data
Mar. 22, 2018 (JP) 2018-053868

(51) Int. Cl. G06F 16/901

(52) U.S. Cl. CPC G06F 16/9024; G06F 16/9027

(57) ABSTRACT

An optimal solution search technique that guarantees an optimal solution for a non-convex sparse optimization problem with a smaller amount of computation is disclosed. An aspect of the present invention relates to an optimal solution search device including: a main device unit that executes best-first search with respect to a given objective function and a given condition; and a calculation unit that calculates a priority of the best-first search.

### TECHNICAL FIELD

The present invention relates to a non-convex sparse optimization problem appearing in the field of sparse estimation or the like.

### BACKGROUND ART

A non-convex sparse optimization problem is a problem of minimizing the value of a function P(x) for x under a constraint that a variable vector x∈R^{d} having d components has only k (k<d) non-zero components.

For example, a non-convex sparse optimization problem appears in such a situation that it is desired to remove noise from a signal having d values including noise to recover the value of a true signal made up of k non-zero components.

As for a non-convex sparse optimization problem, a method which provides a fast solution but cannot guarantee obtaining an optimal solution has been widely studied as in NPL 1. On the other hand, a method other than a simple full search method of testing all methods of selecting k components that may take non-zero values among d components is not known as a method for reliably obtaining an optimal solution.

### CITATION LIST

### Non Patent Literature

[NPL 1] Bo Liu, Xiao-Tong Yuan, Lezi Wang, Qingshan Liu and Dimitris N. Metaxas, “Dual Iterative Hard Thresholding: From Non-convex Sparse Minimization to Non-smooth Concave Maximization”, Proceedings of the 34th international Conference on Machine Learning, 70: 2179-2187, 2017.

[NPL 2] Judea Pearl, “Intelligent Search Strategies for Computer Problem Solving”, Addison-Wesley Longman Publishing Co., Inc., 1984.

### SUMMARY OF THE INVENTION

### Technical Problem

Although such a simple method is presently the sole method as a method for reliably obtaining an optimal solution, it is necessary to solve an optimization problem for all patterns of _{d}Cₖ, which incurs a huge amount of computation.

With the foregoing in view, an object of the present invention is to provide an optimal solution search technique that guarantees an optimal solution for a non-convex sparse optimization problem with a smaller amount of computation.

### Means for Solving the Problem

In order to solve the problem, an aspect of the present invention relates to an optimal solution search device including: a main device unit that executes best-first search with respect to a given objective function and a given condition; and a calculation unit that calculates a priority of the best-first search.

### Effects of the Invention

According to the present invention, it is possible to provide an optimal solution search technique that guarantees an optimal solution for a non-convex sparse optimization problem with a smaller amount of computation.

### BRIEF DESCRIPTION OF DRAWINGS

FIG. 1 is a diagram illustrating a specific example of a state space tree according to an embodiment of the present invention.

FIG. 2 is a block diagram illustrating a functional configuration of an optimal solution search device according to an embodiment of the present invention.

FIG. 3 is a diagram illustrating a pseudocode of best-first search according to an embodiment of the present invention.

FIG. 4 is a diagram illustrating a pseudocode of ORACLE(S) according to an embodiment of the present invention.

FIG. 5 is a flowchart illustrating an optimal solution search process according to an embodiment of the present invention.

FIG. 6 is a diagram illustrating comparison between the running times of an optimal solution search process according to an embodiment of the present invention and a full search method according to the conventional technique.

### DESCRIPTION OF EMBODIMENTS

In the following embodiment, an optimal solution search device that provides an optimal solution for a non-convex sparse optimization problem is disclosed. An optimal solution search device according to an embodiment to be described later uses best-first search (for example, see NPL 2) as an approach for searching for an optimal pattern of non-zero components. Moreover, in priority calculation of the best-first search, the optimal solution search device applies a method for solving a minimization problem in which all patterns of non-zero component are designated as will be described in detail later rather than using DIHT (Dual Iterative Hard Thresholding) as disclosed in NPL 1.

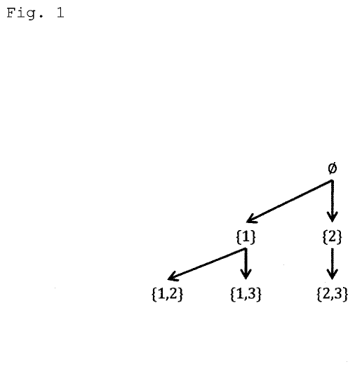

First, an optimal solution search process according to an embodiment of the present invention will be described briefly with reference to FIG. 1.

When a d-dimension vector x∈R^{d} is given for an arbitrary positive integer m (where [m]={1,2, . . . , m}), the number of non-zero components of the vector x is defined as follows.

∥x∥₀ [Formula. 1]

Furthermore, P:R^{d}→R is a function (an objective function) in which the vector x is a variable.

Hereinafter, a case of calculating an optimal solution for the following minimization problem (that is, x that minimizes the value of P(x) of which the number of non-zero components is k or smaller) for a given positive integer k that is equal to smaller than d will be considered.

$${minimize}_{x ∈ {R}^{d}} P ( x ) subject to {‖ x ‖}_{0} \leq k . \qquad [ Formula . 2 ]$$

First, best-first search for this problem will be described. This search is performed on a state space tree defined as follows. A state space tree G=(V,E) is a tree structure in which V is a vertex set and E is a directed branch set. Here, for a given S⊆[d], the number of elements of S is represented by |S|, and the largest value of the positive integers included in S is represented by maxS. In this case, V can be defined as follows.

V:={S⊆[d]||S|≤k and k−|S|≤d−max S}. [Formula. 3]

Moreover, E can be defined as follows.

E:={(S,T)∈V×V|S=T\{maxT}}. [Formula. 4]

That is, G is a tree structure in which an empty set represented as follows is a root.

∅∈V [Formula. 5]

For example, FIG. 1 illustrates G when d=3 and k=2. For example, since the following relationship is satisfied between {1} and {1, 3}, a directed branch ({1}, {1, 3}) is present in E.

{1}={1, 3}\{max{1, 3}} [Formula. 6]

In the optimal solution search device of the present embodiment finds out an optimal occurrence pattern of non-zero components by performing search on a state space tree defined in this manner, which will be described in detail later.

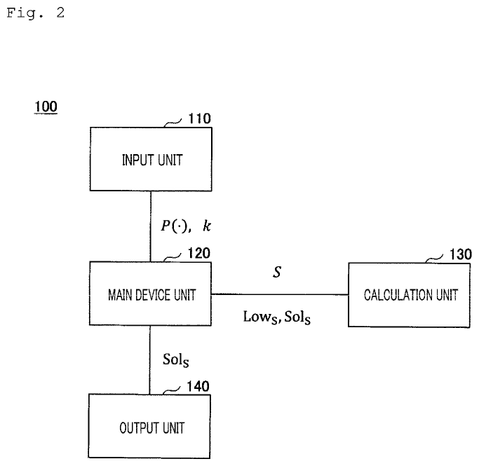

FIG. 2 is a block diagram illustrating a functional configuration of an optimal solution search device according to an embodiment of the present invention.

As illustrated in FIG. 2, an optimal solution search device 100 includes an input unit 110, a main device unit 120, a calculation unit 130, and an output unit 140.

The input unit 110 receives an objective function P(.) and a condition k for best-first search as input data and delivers the same to the main device unit 120.

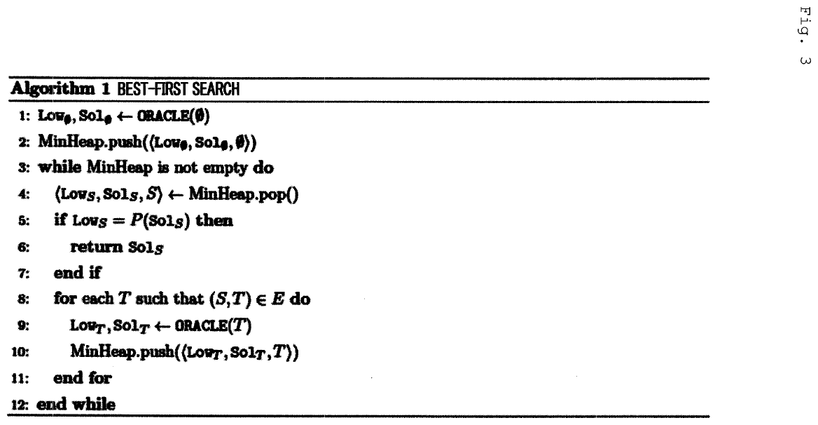

The main device unit 120 executes best-first search with respect to the input objective function P(.) and condition k. Specifically, the main device unit 120 executes best-first search according to such a calculation procedure of Algorithm 1 as illustrated in FIG. 3.

Here, the search uses a data structure called a MinHeap known in this technical field. MinHeap is a data structure that stores a triad <Lowₛ, Solₛ, S> wherein S∈V, Lowₛ∈V which is a value calculated for S, and Solₛ∈R^{d} which is a solution made up of k or smaller non-zero components. MinHeap.push(<Lowₛ, Solₛ, S>) enables a new triad <Lowₛ, Solₛ, S> to be added to MinHeap. Moreover, MinHeap.pop( ) enables a triad <Lowₛ, Solₛ, S> in which the value of Lowₛ is the smallest to be removed from the triads stored in the MinHeap.

In Algorithm 1 illustrated in FIG. 3, the procedure of the best-first search is described assuming that ORACLE(S) to be described later can be used as means for calculating Lowₛ and Solₛ for a given S. In this procedure, search proceeds sequentially from the smaller portions of Lowₛ until S wherein Lowₛ=P(Solₛ) is obtained. That is, it is regarded that the smaller the value of Lowₛ, the higher is the priority. As illustrated in when the priority Lowₛ and the objective function P(Solₛ) have the same value, the main device unit 120 acquires the vale Solₛ of the objective function P(Solₛ) as an optimal solution and ends the best-first search.

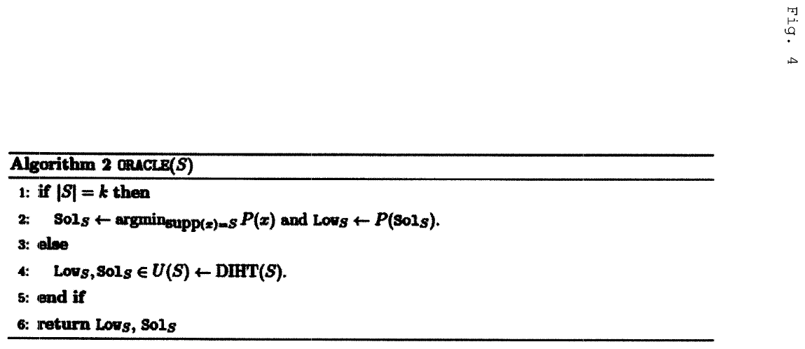

The calculation unit 130 calculates the priority of the best-first search. Specifically, the calculation unit 130 implements ORACLE(S) in the best-first search. That is, the calculation unit 130 executes such a calculation procedure of Algorithm 2 as illustrated in FIG. 4. It is assumed that supp(x)⊆[d] represents a set of suffixes in which x is non-zero.

First, when |S|=k, the calculation unit 130 acquires Solₛ and Lowₛ by solving the minimization problem in which all patterns of k non-zero components are designated.

min_{supp(x)=S}P(x) [Formula. 7]

That is, when the number |S| of elements of a given set S is the same as the positive integer k, the calculation unit 130 calculates the priority by solving a minimization problem in which all patterns of k non-zero components are designated. Solving this problem itself can be realized using a basic optimization method widely known in this technical field.

On the other hand, when |S|<k, the calculation unit 130 can calculate Solₛ and Lowₛ using the DIHT method proposed in NPL 1, for example. Since DIHT is outside the scope of the present invention, description of the details thereof will be omitted.

The output unit 140 outputs the optimal solution Solₛ acquired in the best-first search.

Here, the optimal solution search device 100 may typically be realized as a calculation device such as a server, and for example, may be configured as a drive device, an auxiliary storage device, a memory device, a processor, an interface device, and a communication device which are mutually connected via a bus. Various computer programs including a program that realizes various functions and processes of the optimal solution search device 100 may be provided in the form of a recording medium such as a compact disk-read only memory (CD-ROM), a digital versatile disk (DVD), or a flash memory . When the recording medium having a program stored therein is set on the drive device, the program is installed from the recording medium to the auxiliary storage device via the drive device. However, installation of the program may not necessarily be performed by the recording medium, but the program may be downloaded from an external device via a network or the like. The auxiliary storage device stores the installed program and stores necessary files, data, and the like. The memory device reads and stores programs and data from the auxiliary storage device when a program activation instruction is issued. The processor executes various functions and processes of the optimal solution search device 100 according to various pieces of data such as the program stored in the memory device and parameters necessary for executing the program. The interface device is used as a communication interface for connecting to a network or an external device. The communication device executes various communication processes for communicating with a network such as the Internet.

However, the optimal solution search device 100 is not limited to the above-described hardware configuration, but may be realized by another appropriate hardware configuration.

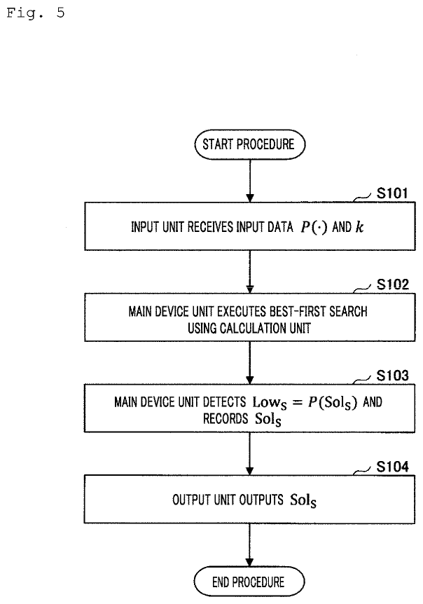

FIG. 5 is a flowchart illustrating an optimal solution search process according to an embodiment of the present invention.

In step S101, the input unit 110 receives a function P and an upper-limit number k of non-zero components during activation of the device, for example.

In step S102, the main device unit 120 executes best-first search on a state space tree. When the state space tree is already constructed in advance, since a huge amount of memory is required, as illustrated in Algorithm 1, the main device unit 120 may perform search sequentially from portions necessary during execution. When it is necessary to calculate Lowₛ and Solₛ during search, the main device unit 120 delivers S to the calculation unit 130 and acquires Lowₛ and Solₛ calculated by ORACLE(S) from the calculation unit 130.

In step S103, as illustrated in Algorithm 1, upon detecting Lowₛ=P(Solₛ), the main device unit 120 determines and records the Solₛ as an optimal solution.

Instep S104, the output unit 140 outputs the optimal solution Solₛ.

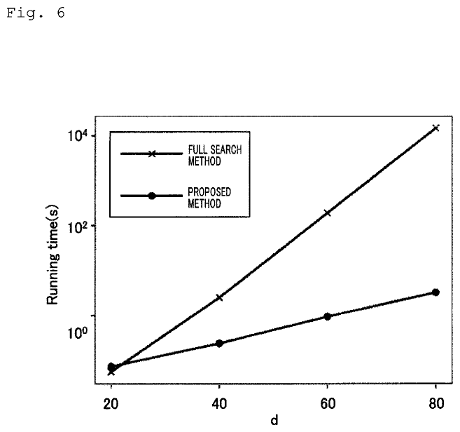

According to the optimal solution search device 100 of the above-described embodiment, since the best-first search and the ORACLE are combined, it is possible to solve the non-convex sparse optimization problem faster than the full search method of the conventional technique. FIG. 6 is a diagram illustrating comparison between the running times of the optimal solution search process according to an embodiment of the present invention and the full search method according to the conventional technique. A case where d=20, 40, 60, and 80 and k=0.05d are used as a problem size will be considered. As illustrated in the drawing, it is observed that the optimal solution search process of the present embodiment can calculate an optimal solution up to 1000 times or more faster than the full search method. Moreover, from the tendency of the drawing, it is expected that a larger difference in calculation time will be obtained for a larger problem size.

While an embodiment of the present invention has been described, the present invention is not limited to the above-described specific embodiment, but various modifications and changes can be made without departing from the spirit of the present invention described in the claims.

### REFERENCE SIGNS LIST

100: Optimal solution search device

110: Input unit

120: Main device unit

130: Calculation unit

140: Output unit

1.-5. (canceled)

6. A computer-implemented method for aspects of a sparse estimation of data, the method comprising:
receiving an objective function and a condition value for performing a best-first search;
determining, based on the received objective function and the condition value, a priority value of the first-best search, wherein the priority value specifies a solution of the objective function; and
generating an output value of the objective function based on the determined priority value; and
providing the output value of the objective function as a result of the best-first search for the sparse estimation.

7. The computer-implemented method of claim 6, wherein the objective function includes one or more non-zero parts, wherein the condition value indicates a maximum number of non-zero parts of the objective function, and the method further comprising:
receiving a plurality of data;
determining, based on a number of data in the received plurality of data and the received condition value, the priority value by solving a minimization problem, wherein the minimization problem includes all patterns of non-zero parts of the objective functions according to the condition value; and
determining, based on the priority value and the output value of the received objective function, the output value of the received objective function as an output of the best-first search.

8. The computer-implemented method of claim 7, wherein the number of data in the received plurality of data and the received condition value are identical, and wherein the priority value and the output value of the received objective function are identical.

9. The computer-implemented method of claim 7, the method further comprising:
generating, a state space tree, wherein the state space tree includes a plurality of vertices and a plurality of edges, wherein each vertex includes:
the priority value of one of the plurality of data,
the output value of the received objective function based on the one of the plurality of data according to the condition value, and
the one of the plurality of data; and
determining the output of the best-first search using the state space tree.

10. The computer-implemented method of claim 9, wherein the state space tree is based on a MinHeap data structure.

11. The computer-implemented method of claim 10, the method further comprises:
identifying one of the plurality of data for the best-first search;
generating data associated with a new vertex of the state space tree based on the identified one of the plurality of data; and
updating the state space tree based on the new vertex.

12. The computer-implemented method of claim 10, the method further comprising;
identifying a vertex of the state space tree, wherein the vertex includes the smallest priority value among the plurality of vertices in the state space tree;
providing data associated with the vertex; and
removing the vertex from the state space tree.

13. A system for aspects of a sparse estimation of data, the system comprises:
a processor; and
a memory storing computer-executable instructions that when executed by the processor cause the system to:
receive an objective function and a condition value for performing a best-first search;
determine, based on the received objective function and the condition value, a priority value of the first-best search, wherein the priority value specifies a solution of the objective function; and
generate an output value of the objective function based on the determined priority value; and
provide the output value of the objective function as a result of the best-first search for the sparse estimation.

14. The system of claim 13, wherein the objective function includes one or more non-zero parts, wherein the condition value indicates a maximum number of non-zero parts of the objective function, and the computer-executable instructions when executed further causing the system to:
receive a plurality of data;
determine, based on a number of data in the received plurality of data and the received condition value, the priority value by solving a minimization problem, wherein the minimization problem includes all patterns of non-zero parts of the objective functions according to the condition value; and
determine, based on the priority value and the output value of the received objective function, the output value of the received objective function as an output of the best-first search.

15. The system of claim 14, wherein the number of data in the received plurality of data and the received condition value are identical, and wherein the priority value and the output value of the received objective function are identical.

16. The system of claim 14, the computer-executable instructions when executed further causing the system to:
generate, a state space tree, wherein the state space tree includes a plurality of vertices and a plurality of edges, wherein each vertex includes:
the priority value of one of the plurality of data,
the output value of the received objective function based on the one of the plurality of data according to the condition value, and
the one of the plurality of data; and
determine the output of the best-first search using the state space tree.

17. The system of claim 16, wherein the state space tree is based on a MinHeap data structure.

18. The system of claim 17, the computer-executable instructions when executed further causing the system to:
identify one of the plurality of data for the best-first search;
generate data associated with a new vertex of the state space tree based on the identified one of the plurality of data; and
update the state space tree based on the new vertex.

19. The system of claim 17, the computer-executable instructions when executed further causing the system to:
identify a vertex of the state space tree, wherein the vertex includes the smallest priority value among the plurality of vertices in the state space tree;
provide data associated with the vertex; and
remove the vertex from the state space tree.

20. A computer-readable non-transitory recording medium storing computer-executable instructions that when executed by a processor cause a computer system to:
receive an objective function and a condition value for performing a best-first search;
determine, based on the received objective function and the condition value, a priority value of the first-best search, wherein the priority value specifies a solution of the objective function; and
generate an output value of the objective function based on the determined priority value; and
provide the output value of the objective function as a result of the best-first search for the sparse estimation.

21. The computer-readable non-transitory recording medium of claim 20, wherein the objective function includes one or more non-zero parts, wherein the condition value indicates a maximum number of non-zero parts of the objective function, and the computer-executable instructions when executed further causing the system to:
receive a plurality of data;
determine, based on a number of data in the received plurality of data and the received condition value, the priority value by solving a minimization problem, wherein the minimization problem includes all patterns of non-zero parts of the objective functions according to the condition value; and
determine, based on the priority value and the output value of the received objective function, the output value of the received objective function as an output of the best-first search.

22. The computer-readable non-transitory recording medium of claim 21, wherein the number of data in the received plurality of data and the received condition value are identical, and wherein the priority value and the output value of the received objective function are identical.

23. The computer-readable non-transitory recording medium of claim 21, the computer-executable instructions when executed further causing the system to:
generate, a state space tree, wherein the state space tree includes a plurality of vertices and a plurality of edges, wherein each vertex includes:
the priority value of one of the plurality of data,
the output value of the received objective function based on the one of the plurality of data according to the condition value, and
the one of the plurality of data; and
determine the output of the best-first search using the state space tree.

24. The computer-readable non-transitory recording medium of claim 23, wherein the state space tree is based on a MinHeap data structure.

25. The computer-readable non-transitory recording medium of claim 24, the computer-executable instructions when executed further causing the system to:
identify a vertex of the state space tree, wherein the vertex includes the smallest priority value among the plurality of vertices in the state space tree;
provide data associated with the vertex; and
remove the vertex from the state space tree.
